(19) United States
(12) Patent Application Publication
(10) Pub. No.: US 2026/0052482 A1
(43) Pub. Date: Feb. 19, 2026

(54) Dynamic Transmission Power Indication for PDSCH

(71) Applicant: Apple Inc., Cupertino, CA (US)

(72) Inventors: Hong HE, San Jose, CA (US); Dawei ZHANG, Saratoga, CA (US); Wei ZENG, Saratoga, CA (US); Oghenekome OTERI, San Diego, CA (US); Weidong YANG, San Diego, CA (US)

(21) Appl. No.: 19/102,980

(22) PCT Filed: Aug. 10, 2023
(86) PCT No.: PCT/US2023/029989

§ 371 Date: Feb. 11, 2025

Related U.S. Application Data
(60) Provisional application No. 63/371,103, filed on Aug. 11, 2022.

(51) Int. Cl. H04W 52/14; H04W 52/16

(52) U.S. Cl. CPC H04W 52/143; H04W 52/16

(57) ABSTRACT

A user equipment (UE) configured to decode, based on signals received from a base station, a set of power offset values from a base station, decode, based on signals received from the base station, a downlink control information (DCI), the DCI indicating a power offset value from the set of power offset values and determine a transmission power for physical downlink shared channel (PDSCH) to be transmitted by the base station based on at least the power offset value indicated by the DCI.

### PRIORITY/INCORPORATION BY REFERENCE

This application claims priority to U.S. Provisional Application Ser. No. 63/371,103 filed on Aug. 11, 2022, and entitled “Dynamic Transmission Power Indication for PDSCH,” the entirety of which is incorporated herein by reference.

### BACKGROUND

A user equipment (UE) may connect to a network via a base station. Typically, energy saving techniques that are implemented on the network side and/or the UE side are designed to conserve power at the UE. However, energy consumption is also a concern on the network side and techniques designed to mitigate network power consumption may also be utilized.

The network may utilize a network power saving technique comprising dynamically changing the transmission power for physical downlink shared channel (PDSCH) transmissions. For example, the base station may reduce the PDSCH transmission power for one or more UEs with good coverage to save energy without negatively impacting performance. It has been identified that there is a need for techniques configured to enable the UE to determine when the network has dynamically changed the PDSCH transmission power to support the implementation of this type of network power saving technique.

### SUMMARY

Some exemplary embodiments are related to an apparatus of a user equipment (UE), the apparatus having processing circuitry configured to decode, based on signals received from a base station, a set of power offset values from a base station, decode, based on signals received from the base station, a downlink control information (DCI), the DCI indicating a power offset value from the set of power offset values and determine a transmission power for physical downlink shared channel (PDSCH) to be transmitted by the base station based on at least the power offset value indicated by the DCI.

Other exemplary embodiments are related to a processor configured to decode, based on signals received from a base station, a set of power offset values from a base station, decode, based on signals received from the base station, a downlink control information (DCI), the DCI indicating a power offset value from the set of power offset values and determine a transmission power for physical downlink shared channel (PDSCH) to be transmitted by the base station based on at least the power offset value indicated by the DCI.

Still further exemplary embodiments are related to an apparatus of a base station, the apparatus having processing circuitry configured to configure transceiver circuitry to transmit a set of power offset values to a user equipment (UE) and configure transceiver circuitry to transmit a downlink control information (DCI) to the UE, the DCI indicating a power offset value from the set of power offset values, wherein the UE determines a transmission power for physical downlink shared channel (PDSCH) to be transmitted by the base station based on at least the power offset value indicated by the DCI.

Additional exemplary embodiments are related to a processor configured to configure transceiver circuitry to transmit a set of power offset values to a user equipment (UE) and configure transceiver circuitry to transmit a downlink control information (DCI) to the UE, the DCI indicating a power offset value from the set of power offset values, wherein the UE determines a transmission power for physical downlink shared channel (PDSCH) to be transmitted by the base station based on at least the power offset value indicated by the DCI.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a signaling diagram for dynamic transmission power indication for physical downlink shared channel (PDSCH) according to various exemplary embodiments.

FIG. 5 shows a DCI format 2_Z according to various exemplary embodiments.

FIG. 6 shows a DCI format 1_1 according to various exemplary embodiments.

### DETAILED DESCRIPTION

The exemplary embodiments may be further understood with reference to the following description and the related appended drawings, wherein like elements are provided with the same reference numerals. The exemplary embodiments relate to network power saving. As will be described in more detail below, the exemplary techniques introduced herein may be used to mitigate the impact of certain types of network power saving mechanisms on user equipment (UE) and/or network performance.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

The network may implement a network power saving mechanism where the network dynamically changes the transmission power for physical downlink shared channel (PDSCH) transmission. For example, the gNB may decide to reduce the PDSCH transmission power for UEs that satisfy certain conditions. Typically, transmission power for PDSCH is fixed by the gNB for all UEs in a cell. As a result, UEs in good coverage may experience high signal-to-interference-to-noise (SINR) levels. Thus, PDSCH transmission power may be reduced for certain UEs (e.g., UEs deployed in good coverage, etc.) to achieve network power saving benefits without causing performance loss for those UEs.

According to some aspects, the exemplary embodiments introduce techniques related to signaling a transmission power indication for PDSCH to support dynamically changing PDSCH transmission power for network power saving. The exemplary techniques introduced herein may be used independently from one another, in conjunction with other currently implemented transmission power indication techniques, future implementations of transmission power indication techniques or independently from other transmission power indication techniques.

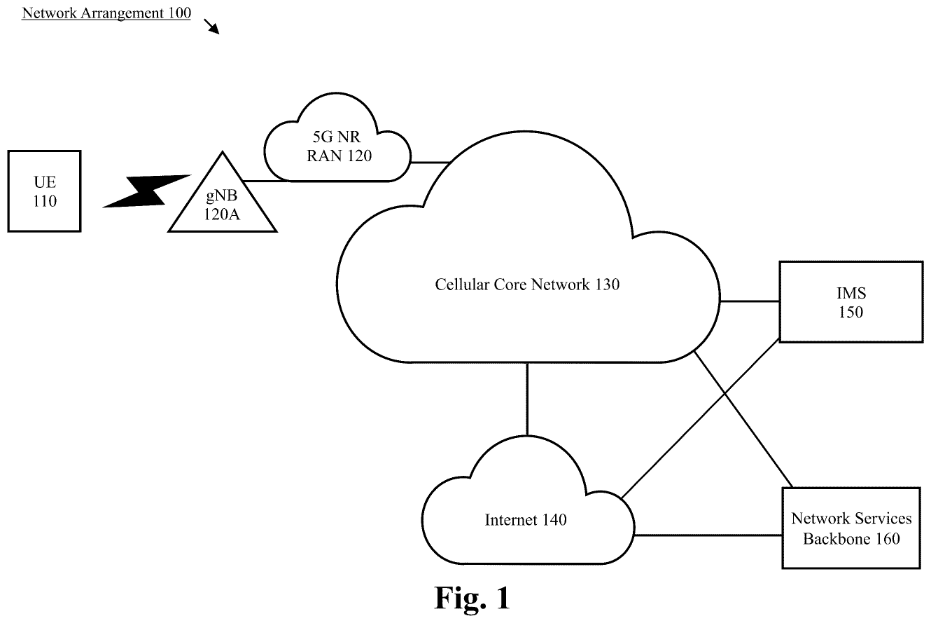

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam. As indicated above, in some examples, the terms “TRP” and “cell” may be used interchangeably to generally refer to the same connection and/or node.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

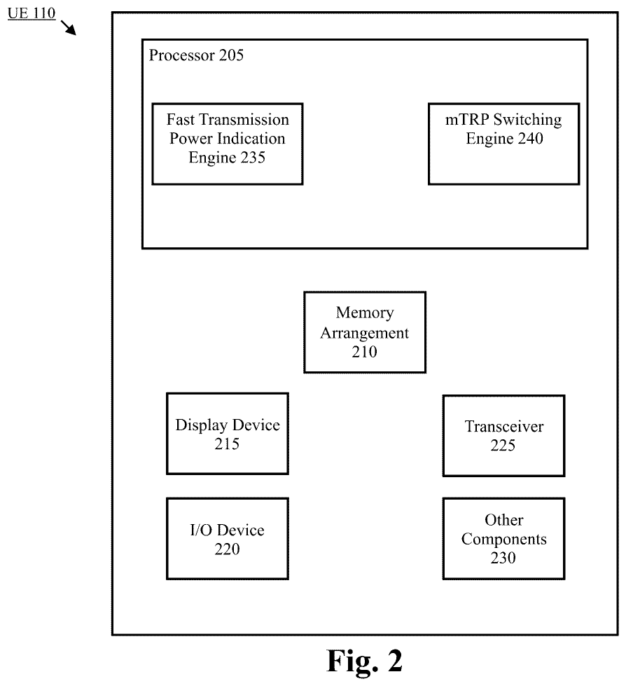

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a fast transmission power indication engine 235. The fast transmission power indication engine 235 may perform various operations related to determining whether a change to transmission power has occurred for various types of downlink signals and/or channels. To provide some general examples, the fast transmission power engine 235 may perform operations such as, but not limited to, receiving a set of power offset values, receiving downlink control information (DCI) and determining a transmission power for certain downlink signals and/or channels that are to be received by the UE 110.

The above referenced engines 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 may encompass an advanced receiver (e.g., E-MMSE-RC, R-ML, etc.) for MU-MIMO. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

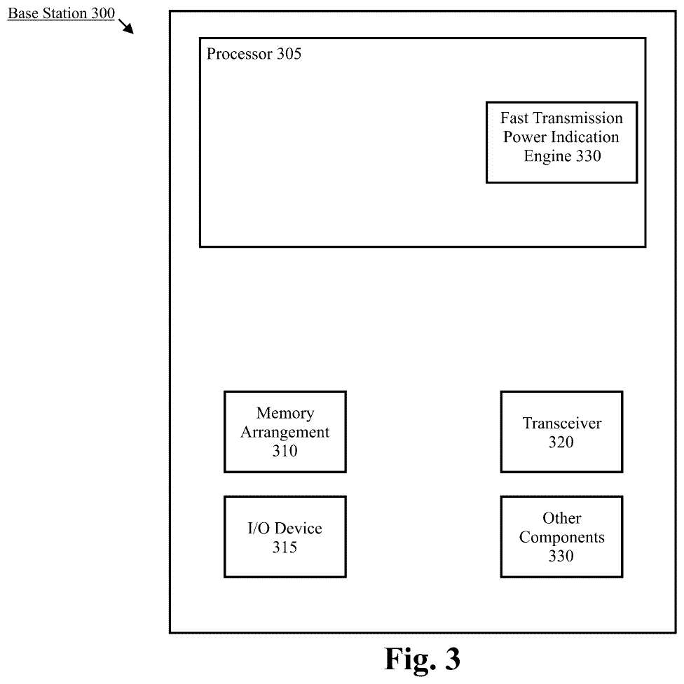

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include a fast transmission power indication engine 330. The fast transmission power indication engine 330 may perform various operations related to signaling that a change to transmission power has occurred for various types of downlink signals and/or channels. To provide some general examples, the fast transmission power engine 330 may perform operations such as, but not limited to, transmitting a set of power offset values and DCI that enables the UE 110 to determine a transmission power for certain downlink signals and/or channels.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

According to some aspects, the exemplary embodiments relate to a network power saving technique where the gNB 120A dynamically changes a PDSCH transmission power for certain UEs. The exemplary embodiments introduce techniques related to signaling a transmission power indication for PDSCH to support dynamically changing PDSCH transmission power for network power saving.

Typically, a downlink transmission power for PDSCH is fixed by the gNB for all UEs in a cell. As a result, UEs in good coverage may experience high SINR levels. Thus, PDSCH transmission power may be reduced for certain UEs (e.g., UEs deployed in good coverage, etc.) to achieve network power saving benefits without causing performance loss for those UEs.

Changing the PDSCH transmission power without notifying the UE 110 may have a negative impact on procedures such as CSI feedback, rank indication (RI), precoding matrix indication (PMI), and may eventually degrade PDSCH performance. Under conventional circumstances, the network may signal a power offset between PDSCH resources and CSI-RS resources to the UE 110 via RRC signaling. For instance, a powerControlOffset IE indicating a power offset between PDSCH resource elements and NZP CSI-RS resources elements may be provided to the UE 110 in an RRC message. However, the speed at which this procedure may be performed is undesirable for the dynamic nature of a network power saving technique where a PDSCH transmission power is changes for UEs that satisfy certain conditions.

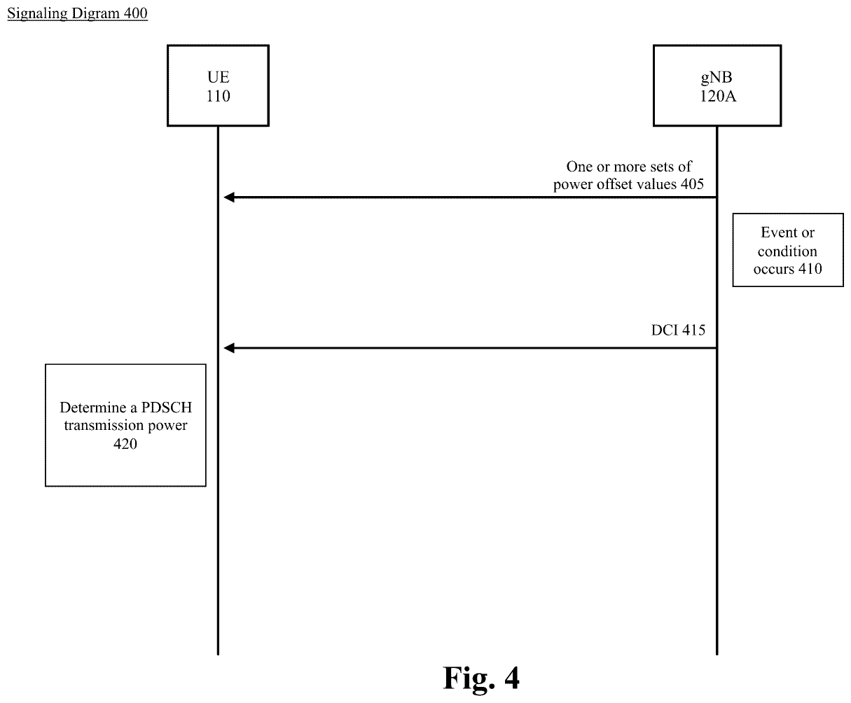

FIG. 4 shows a signaling diagram 400 for dynamic transmission power indication for PDSCH according to various exemplary embodiments. The signaling diagram 400 includes the UE 110 and the gNB 120A of the network arrangement 100 of FIG. 1.

In 405, one or more sets of power offset values are provided to the UE 110. As will be described in more detail below, the power offset values may enable the UE 110 to determine a transmission power for PDSCH. The one or more sets of power offset values may be provided by RRC signaling or in any other appropriate manner. Additional details regarding the power offset values are provided below during the description of 415 of the signaling diagram 400.

In 410, an event or condition occurs that causes a change to a PDSCH transmission power parameter. For example, the gNB 120A may reduce a PDSCH transmission power for UEs that are considered to be in good or adequate coverage. However, the manner in which the transmission power update is triggered and performed is beyond the scope of exemplary embodiments. Instead, the exemplary embodiments introduce techniques for signaling the transmission power indication for PDSCH after an event or condition causes a change to a PDSCH transmission power parameter.

In 415, DCI is transmitted to the UE 110 by the gNB 120A. The DCI may notify the UE 110 that a transmission power update for PDSCH has occurred at the gNB 120A. In addition, the DCI may indicate that one or more of the previously provided power offset values may be used to determine PDSCH transmission power. In some embodiments, the DCI in 415 is an already defined DCI format that has been configured to provide this type of information.

In other embodiments, a new DCI format may be introduced for indicating a transmission power update for certain types of downlink signals to one or more UEs. Throughout this description, the new DCI format may be referred to as “DCI format 2_Z.” The exemplary DCI format 2_Z may be cyclic CRC scrambled by TP-PDSCH-RNTI. The TP-PDSCH-RNTI may be provided to the UE 110 using RRC signaling or in any other appropriate manner. However, reference to DCI format 2_Z is merely provided for illustrative purposes, the 2_Z classification provided herein may serve as a placeholder. In an actual deployment scenario, the new DCI format may be assigned any appropriate number or label.

As described above, in 405, one or more sets of power offset values may be provided to the UE 110. The power offset values for PDSCH transmission power may be represented by

$${β}_{offset}^{PDSCH , 0} , {β}_{offset}^{PDSCH , 1} , … {β}_{offset}^{PDSCH , D - 1}$$

where the value of (D) is based on a tradeoff between signaling overhead of DCI and the required power scaling range of PDSCH transmission (e.g., the range of antenna port numbers for PDSCH transmission that may be dynamically muted) and set of power offset values for PDSCH transmission may be represented by

$${β}_{offset}^{PDSCH , i} ,$$

0≤i<D.

The DCI format 2_Z may include one or more PDSCH power scaling indications (PDSCH-PSI) (e.g., PDSCH-PSI #1, PDSCH-PSI #2 . . . . PDSCH-PSI #G). In some embodiments, the PDSCH-PSI may include [log₂N] bits and be used to indicate a power offset value previously provided to the UE 110 in 405.

In 420, the UE 110 determines a PDSCH transmission based on the indicated power offset value. For example, the indicated

$${β}_{offset}^{PDSCH , i} ,$$

0≤i<D may be used by the UE 110 to determine the actual PDSCH transmission power.

In some embodiments, the UE 110 may be configured by higher layers with a starting position of a PDSCH-PSI field. This approach may allow for different field sizes for PDSCH-PSI fields in a same DCI format 2_Z for different groups of UEs such that the DCI size may be minimized. For example, a first group of one or more UEs may be assigned a first PDSCH-PSI field and a second set of one or more UEs may be assigned a second PDSCH-PSI field of the same DCI format 2_Z. The number of bits of the DCI format 2_Z may be configured via RRC signaling or provided to the UE 110 in any other appropriate manner. In some embodiments, the size of the DCI format 2_Z may be equal to or less than the payload size of DCI format 1_0 monitored in the CSS of the same cell.

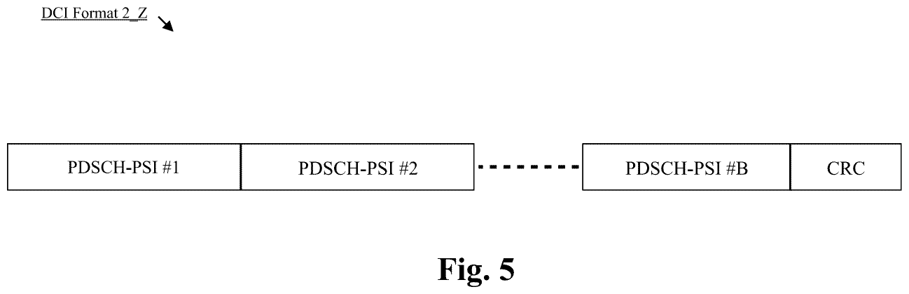

FIG. 5 shows a DCI format 2_Z according to various exemplary embodiments. The DCI format 2_Z may be used for multiple different groups of UEs. For example, the network may arrange a set of one or more UEs into a group based on their respective SINR values. However, the exemplary embodiments are not required to arrange UEs into (B) groups based on the SINR. The exemplary embodiments may use any appropriate indication of a type of coverage experienced by the UEs to arrange them into a group (e.g., good, adequate, poor, etc.) and/or may consider any other appropriate factor. In this example, a first group of UEs may be assigned to PDSCH-PSI #1 for PDSCH transmission power notification. The other PDSCH-PSI fields in the DCI format 2_Z may be used to notify different groups of UEs.

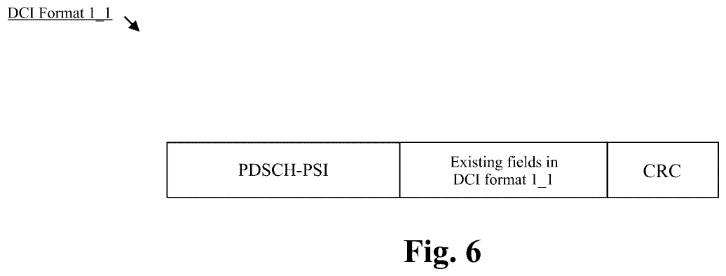

As mentioned above, instead of DCI format 2_Z, the exemplary embodiments may utilize an already defined DCI format to provide information to enable UEs to determine a PDSCH transmission power. According to some aspects, a new PDSCH-PSI field may be added into existing DCI format 1_1 to dynamically indicate the transmission power of PDSCH. An example of this is shown in the DCI format 1_1 of FIG. 6.

### EXAMPLES

In a first example, a method performed by a user equipment (UE), comprising receiving a set of power offset values from a base station, receiving a downlink control information (DCI), the DCI indicating a power offset value from the set of power offset values and determining a transmission power for physical downlink shared channel (PDSCH) to be transmitted by the base station based on at least the power offset value indicated by the DCI.

In a second example, the method of the first example, wherein the set of power offset values comprises one or more power offset values indicating a power offset between PDSCH resource elements and non-zero power (NZP) channel state information (CSI)-reference signal (RS) resource elements.

In a third example, the method of the first example, further comprising receiving one or more radio resource control (RRC) signals comprising a radio network temporary identifier (RNTI) for PDSCH transmission power indication, wherein cyclic redundancy check (CRC) bits of the DCI are scrambled by the RNTI.

In a fourth example, the method of the first example, further comprising receiving an indication of a starting position of a power scaling indication (PSI) field of the DCI assigned to the UE, wherein the DCI is a group common DCI format for a group of UEs.

In a fifth example, the method of the first example, further comprising receiving one or more radio resource control (RRC) signals comprising a parameter indicating a number of information bits of the DCI.

In a sixth example, the method of the first example, wherein the DCI is a DCI format 1_1 comprising a physical downlink shared channel (PDSCH) power scaling indication (PSI) field.

In a seventh example, the method of the first example, wherein the DCI comprises multiple fields, each field corresponding to a different group of UEs.

In an eighth example, the method of the seventh example, wherein each group of UE is arranged based on a signaling to interference to noise ratio (SINR) parameter.

In a ninth example, a processor configured to perform any of the methods of the first through eighth examples.

In a tenth example, a user equipment (UE) comprising a transceiver configured to communicate with a network and a processor communicatively coupled to the transceiver and configured to perform any of the methods of the first through eighth examples.

In an eleventh example, a method is performed by a base station, comprising transmitting a set of power offset values to a user equipment (UE) and transmitting a downlink control information (DCI) to the UE, the DCI indicating a power offset value from the set of power offset values, wherein the UE determines a transmission power for physical downlink shared channel (PDSCH) to be transmitted by the base station based on at least the power offset value indicated by the DCI.

In a twelfth example, the method of the eleventh example, wherein the set of power offset values comprises one or more power offset values indicating a power offset between PDSCH resource elements and non-zero power (NZP) channel state information (CSI)-reference signal (RS) resource elements.

In a thirteenth example, the method of the eleventh example, further comprising transmitting one or more radio resource control (RRC) signals to the UE comprising a radio network temporary identifier (RNTI) for PDSCH transmission power indication, wherein cyclic redundancy check (CRC) bits of the DCI are scrambled by the RNTI.

In a fourteenth example, the method of the eleventh example, further comprising transmitting an indication to the UE indicating a starting position of a power scaling indication (PSI) field of the DCI assigned to the UE, wherein the DCI is a group common DCI format for a group of UEs.

In a fifteenth example, the method of the eleventh example, further comprising transmitting one or more radio resource control (RRC) signals to the UE comprising a parameter indicating a number of information bits of the DCI.

In a sixteenth example, the method of the eleventh example, wherein the DCI is a DCI format 1_1 comprising a physical downlink shared channel (PDSCH) power scaling indication (PSI) field.

In a seventeenth example, the method of the eleventh example, wherein the DCI comprises multiple fields, each field corresponding to a different group of UEs.

In an eighteenth example, the method of the seventeenth example, wherein each group of UEs is arranged based on a signaling to interference to noise ratio (SINR) parameter.

In a nineteenth example, a processor configured to perform any of the methods of the eleventh through eighteenth examples.

In a twentieth example, a base station comprising a transceiver configured to communicate with a user equipment (UE) and a processor communicatively coupled to the transceiver and configured to perform any of the methods of the eleventh through eighteenth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, based on signals received from a base station, a set of power offset values from a base station;
decode, based on signals received from the base station, a downlink control information (DCI), the DCI indicating a power offset value from the set of power offset values; and
determine a transmission power for physical downlink shared channel (PDSCH) to be transmitted by the base station based on at least the power offset value indicated by the DCI.

2. The apparatus of claim 1, wherein the set of power offset values comprises one or more power offset values indicating a power offset between PDSCH resource elements and non-zero power (NZP) channel state information (CSI)-reference signal (RS) resource elements.

3. The apparatus of claim 1, wherein the processing circuitry is further configured to:
decode, based on signals received from the base station, one or more radio resource control (RRC) signals comprising a radio network temporary identifier (RNTI) for PDSCH transmission power indication, wherein cyclic redundancy check (CRC) bits of the DCI are scrambled by the RNTI.

4. The apparatus of claim 1, wherein the processing circuitry is further configured to:
decode, based on signals received from the base station, an indication of a starting position of a power scaling indication (PSI) field of the DCI assigned to the UE, wherein the DCI is a group common DCI format for a group of UEs.

5. The apparatus of claim 1, wherein the processing circuitry is further configured to:
decode, based on signals received from the base station, one or more radio resource control (RRC) signals comprising a parameter indicating a number of information bits of the DCI.

6. The apparatus of claim 1, wherein the DCI is a DCI format 1_1 comprising a physical downlink shared channel (PDSCH) power scaling indication (PSI) field.

7. The apparatus of claim 1, wherein the DCI comprises multiple fields, each field corresponding to a different group of UEs.

8. The apparatus of claim 7, wherein each group of UE is arranged based on a signaling to interference to noise ratio (SINR) parameter.

9. A processor configured to:
decode, based on signals received from a base station, a set of power offset values from a base station;
decode, based on signals received from the base station, a downlink control information (DCI), the DCI indicating a power offset value from the set of power offset values; and
determine a transmission power for physical downlink shared channel (PDSCH) to be transmitted by the base station based on at least the power offset value indicated by the DCI.

10. The processor of claim 9, wherein the set of power offset values comprises one or more power offset values indicating a power offset between PDSCH resource elements and non-zero power (NZP) channel state information (CSI)-reference signal (RS) resource elements.

11. The processor of claim 9, further configured to:
decode, based on signals received from the base station, one or more radio resource control (RRC) signals comprising a radio network temporary identifier (RNTI) for PDSCH transmission power indication, wherein cyclic redundancy check (CRC) bits of the DCI are scrambled by the RNTI.

12. The processor of claim 9, further configured to:
decode, based on signals received from the base station, an indication of a starting position of a power scaling indication (PSI) field of the DCI assigned to a user equipment (UE), wherein the DCI is a group common DCI format for a group of UEs.

13. An apparatus of a base station, the apparatus comprising processing circuitry configured to:
configure transceiver circuitry to transmit a set of power offset values to a user equipment (UE); and
configure transceiver circuitry to transmit a downlink control information (DCI) to the UE, the DCI indicating a power offset value from the set of power offset values, wherein the UE determines a transmission power for physical downlink shared channel (PDSCH) to be transmitted by the base station based on at least the power offset value indicated by the DCI.

14. The apparatus of claim 13, wherein the set of power offset values comprises one or more power offset values indicating a power offset between PDSCH resource elements and non-zero power (NZP) channel state information (CSI)-reference signal (RS) resource elements.

15. The apparatus of claim 13, wherein the processing circuitry is further configured to:
configure transceiver circuitry to transmit one or more radio resource control (RRC) signals to the UE comprising a radio network temporary identifier (RNTI) for PDSCH transmission power indication, wherein cyclic redundancy check (CRC) bits of the DCI are scrambled by the RNTI.

16. The apparatus of claim 13, wherein the processing circuitry is further configured to:
configure transceiver circuitry to transmit an indication to the UE indicating a starting position of a power scaling indication (PSI) field of the DCI assigned to the UE, wherein the DCI is a group common DCI format for a group of UEs.

17. The apparatus of claim 13, wherein the processing circuitry is further configured to:
configure transceiver circuitry to transmit one or more radio resource control (RRC) signals to the UE comprising a parameter indicating a number of information bits of the DCI.

18. The apparatus of claim 13, wherein the DCI is a DCI format 1_1 comprising a physical downlink shared channel (PDSCH) power scaling indication (PSI) field.

19. The apparatus of claim 13, wherein the DCI comprises multiple fields, each field corresponding to a different group of UEs.

20. The apparatus of claim 19, wherein each group of UEs is arranged based on a signaling to interference to noise ratio (SINR) parameter.
